(19) United States
(12) Patent Application Publication
(10) Pub. No.: US 2023/0182512 A1
(43) Pub. Date: Jun. 15, 2023

(54) TIRE WITH CELLULAR MEMBER AND SENSOR

(71) Applicant: The Goodyear Tire & Rubber Company, Akron, OH (US)

(72) Inventors: Adrian Florin Nicula, Luxembourg (LU); Jason Mark Middelberg, (US); Jean-Claude Patrice Philippe Griffoin, Luxembourg (LU); Nicolas Soultis, Freylange (BE); Stephan Peter Hilger, Medell (BE)

(21) Appl. No.: 18/053,543

(22) Filed: Nov. 8, 2022

Related U.S. Application Data
(60) Provisional application No. 63/289,211, filed on Dec. 14, 2021.

(51) Int. Cl. B60C 23/04; G01L 17/00; B60C 19/00

(52) U.S. Cl. CPC B60C 23/0493; G01L 17/005; B60C 19/002

(57) ABSTRACT

A tire, cellular member, and sensor combination includes a tire. The tire includes a pair of sidewalls, a circumferential tread, in which the pair of sidewalls extends to the tread, and an innerliner. A cellular member is disposed on the innerliner and is formed with a sensor opening. A sensor is disposed in the sensor opening and is affixed to the innerliner.

### FIELD OF THE INVENTION

The invention relates to vehicle tires. More particularly, the invention relates to vehicle tires that include sensors to determine various conditions within the tires. Specifically, the invention is directed to a tire that includes a sensor and a cellular member which is adapted for optimum mounting of the sensor.

### BACKGROUND OF THE INVENTION

In the manufacture of a pneumatic tire for a vehicle, the tire is typically built on the drum of a tire-building machine, which is known in the art as a tire building drum. Numerous tire components are wrapped about and/or applied to the drum in sequence, forming a cylindrical-shaped tire carcass. The tire carcass is then expanded into a toroidal shape for receipt of the remaining components of the tire, such as a belt package and a rubber tread. The completed toroidally-shaped unvulcanized tire carcass, which is known in the art at that stage as a green tire, is then inserted into a mold or press for forming of the tread pattern and curing or vulcanization.

Some tires include a sensor for monitoring various parameters. For example, one type of sensor is a tire pressure monitoring system (TPMS) sensor, which enables the pressure inside the tire to be monitored. A TPMS sensor typically includes an antenna for wirelessly transmitting measured data to a receiver unit for processing and/or storage. TPMS sensors are often mounted to an innerliner of the tire through direct attachment using an adhesive. To ensure optimum operation of the TPMS sensor, correct placement of the sensor on the innerliner is important.

Some tires are equipped with cellular members, such as foam strips, which may be mounted in the tire cavity to dampen noise that is generated in the tire during operation of the vehicle. When a TPMS sensor is employed in a tire that is equipped with such a cellular member, the cellular member may interfere with proper mounting, operation, and/or communication of the TPMS sensor.

As a result, there is a need for a tire that includes a cellular member with structural features that enable proper mounting, operation, and communication of a sensor.

### SUMMARY OF THE INVENTION

According to an aspect of an exemplary embodiment of the invention, a tire, cellular member, and sensor combination is provided. The tire includes a pair of sidewalls, a circumferential tread, in which the pair of sidewalls extends to the tread, and an innerliner. A cellular member is disposed on the innerliner and is formed with a sensor opening. A sensor is disposed in the sensor opening and is affixed to the innerliner.

### Definitions

“Axial” and “axially” mean lines or directions that are parallel to the axis of rotation of the tire.

“Axially inward” and “axially inwardly” refer to an axial direction that is toward the axial center of the tire.

“Axially outward” and “axially outwardly” refer to an axial direction that is away from the axial center of the tire.

“Bead” means that part of the tire comprising an annular tensile member wrapped by ply cords and shaped, with or without other reinforcement elements such as flippers, chippers, apexes, toe guards and chafers, to fit the design rim.

“CAN bus” is an abbreviation for controller area network.

“Carcass” means the tire structure apart from the belt structure, tread, undertread, and sidewall rubber over the plies, but including the beads.

“Circumferential” means lines or directions extending along the perimeter of the surface of the annular tread perpendicular to the axial direction.

“Equatorial plane (EP)” means the plane perpendicular to the tire's axis of rotation and passing through the center of its tread.

“Footprint” means the contact patch or area of contact created by the tire tread with a flat surface, such as the ground, as the tire rotates or rolls.

“Inboard side” means the side of the tire nearest the vehicle when the tire is mounted on a wheel and the wheel is mounted on the vehicle.

“Innerliner” means the layer or layers of elastomer or other material that form the inside surface of a tubeless tire and that contain the inflating fluid within the tire.

“Lateral” means an axial direction.

“Lateral edges” means a line tangent to the axially outermost tread contact patch or footprint as measured under normal load and tire inflation, the lines being parallel to the equatorial centerplane.

“Outboard side” means the side of the tire farthest away from the vehicle when the tire is mounted on a wheel and the wheel is mounted on the vehicle.

“Radial” and “radially” mean lines or directions that are perpendicular to the axis of rotation of the tire.

“Radially inward” and “radially inwardly” refer to a radial direction that is toward the central axis of rotation of the tire.

“Radially outward” and “radially outwardly” refer to a radial direction that is away from the central axis of rotation of the tire.

“TPMS” means a tire pressure monitoring system, which is an electronic system that measures the internal pressure of a tire and is capable of communicating the pressure to a processor that is mounted on the vehicle and/or is in electronic communication with electronic systems of the vehicle.

“Tread element” or “traction element” means a rib or a block element defined by a shape having adjacent grooves.

### BRIEF DESCRIPTION OF DRAWINGS

The invention will be described by way of example and with reference to the accompanying drawings, in which:

FIG. 1 is a perspective view of a vehicle and a tire of the prior art equipped with a sensor, with the tire shown partially in section;

FIG. 2 is a perspective view of an exemplary embodiment of a tire, cellular member, and sensor combination of the present invention, with the tire shown partially in section;

FIG. 3 is an enlarged cross-sectional view of a portion of the tire, cellular member, and sensor combination shown in FIG. 2; and

FIG. 4 is an enlarged plan view of a container for a sensor.

Similar numerals refer to similar parts throughout the drawings.

### DETAILED DESCRIPTION OF THE INVENTION

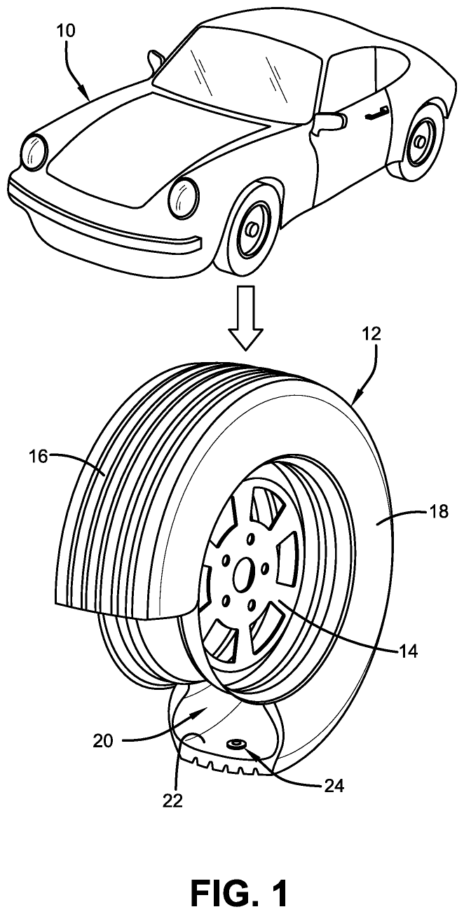

A vehicle 10 and a tire 12 of the prior art are shown in FIG. 1. The tire 12 is of conventional construction, and is mounted on a wheel 14. The tire 12 includes a pair of sidewalls 18 that extend to a circumferential tread 16. An innerliner 22 is formed on an inner surface of the tire 12, and a cavity 20 is formed when the tire 12 is mounted on the wheel 14. The tire 12 may be equipped with a sensor 24, which may be a tire pressure monitoring system (TPMS) sensor, and detects tire parameters such as pressure and/or temperature within the tire cavity 20. The sensor 24 preferably is affixed to the innerliner 22.

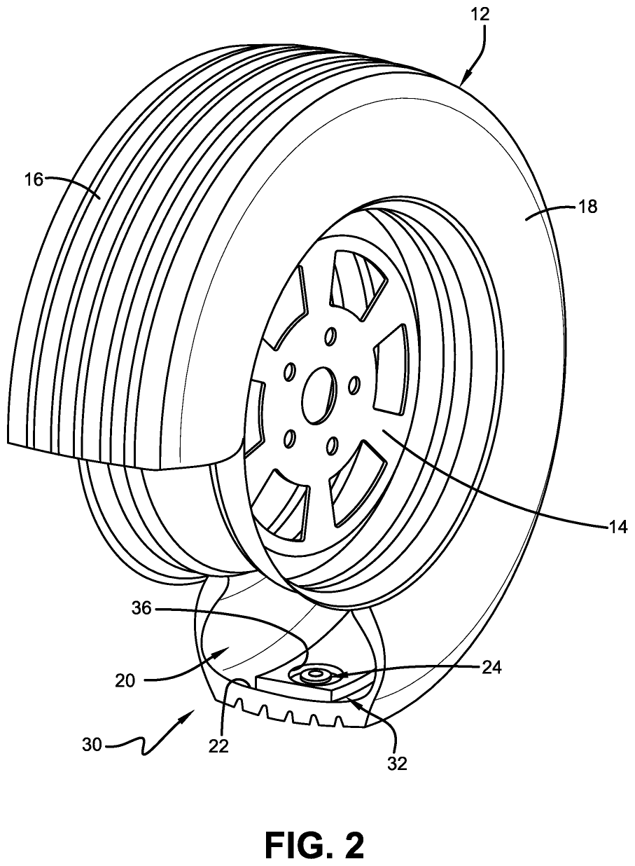

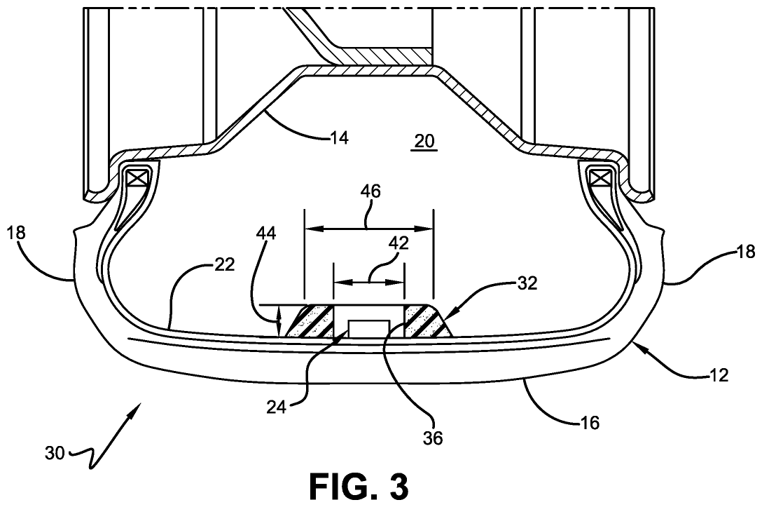

An exemplary embodiment of a tire, cellular member, and sensor combination of the present invention is indicated at 30 in FIGS. 2 and 3. The tire, cellular member, and sensor combination 30 employs a tire 12 and sensor 24 as described above. A cellular member 32 is mounted in the tire 12, and preferably is a circumferentially-extending ring formed of open-cell foam. For example, the cellular member 32 may be formed of a strip of polyurethane foam, and is disposed on the innerliner 22 of the tire 12 to form a ring. Alternatively, the cellular member 32 may be formed of a closed-cell foam. The cellular member 32 preferably is attached to the innerliner 22 with an adhesive. The cellular member 32 is disposed in the tire cavity 20 to dampen noise that occurs in the tire 12 during operation of the vehicle 10.

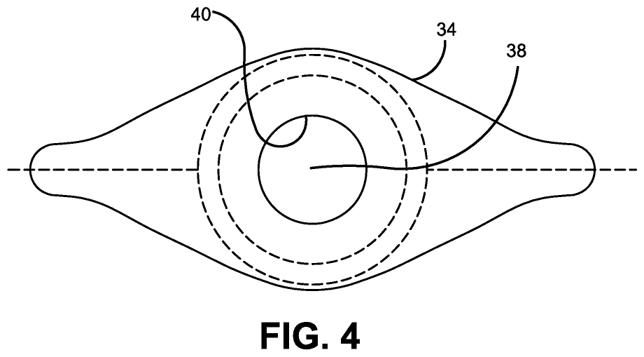

The sensor 24 may be disposed in a sensor container 34, which is shown in FIG. 4. The sensor 24 may be a TPMS sensor that measures the pressure and/or temperature within the tire cavity 20, or may be a sensor that measures other tire parameters, such as speed, acceleration, and the like. The sensor container 34 is preferably formed of an elastomer and includes a central cavity 38 that receives the sensor 24. A container opening 40 is formed in the sensor container 34 to enable the sensor 24 to be inserted and removed from the central cavity 38. When employed, the sensor container 34 is attached to the innerliner 22 of the tire 12 by an adhesive. The sensor container 34 allows for secure positioning of the sensor 24, while also providing for easy removal and replacement of the sensor.

An exemplary sensor container 34 is shown and described in U.S. Pat. No. 6,899,153, which is owned by the Assignee of the present invention, The Goodyear Tire & Rubber Company, and which is incorporated herein by reference. Alternatively, when the sensor container 34 is not employed, the sensor 24 may be attached directly to the innerliner 22 by an adhesive.

As shown in FIGS. 2 and 3, the cellular member 32 is formed with a sensor opening 36. The sensor opening 36 preferably is formed as a closed-wall geometric shape, such as a circular shape. The sensor opening 36 may alternatively be formed in an oval shape, a square shape, a rectangular shape, a hexagonal shape, an octagonal shape, and the like. The sensor opening 36 includes a diameter 42 that is smaller than a minimum axial width 46 of the cellular member 32. The sensor opening 36 extends through an entire radial thickness 44 of the cellular member 32, so that the opening extends between the cavity 20 and the innerliner 22.

The diameter 42 of the sensor opening 36 preferably is near the size of the sensor 24 or is larger than the sensor. Such a diameter 42 enables the sensor 24 to be inserted directly through the sensor opening 36, or to stretch or flex the cellular member 32 at the sensor opening to install the sensor through the opening. The diameter 42 of the sensor opening 36 may also be near the size of the sensor container 34 or larger than the sensor container 34, when the sensor container is employed. Such a diameter 42 enables the sensor container 34 to be inserted directly through the sensor opening 36, or to stretch or flex the cellular member 32 at the sensor opening to install the sensor container through the opening, when the sensor container is employed.

In this manner, the sensor opening 36 enables the sensor 24 to be directly attached to the innerliner 22 when the sensor container 34 is not employed, while the sensor remains in direct communication with the tire cavity 20 for accurate cavity pressure and/or temperature measurements. When the sensor container 34 is employed, the sensor opening 36 enables the container and the sensor 24 to be attached to the innerliner, while the sensor remains in direct communication with the tire cavity 20 for accurate cavity pressure and/or temperature measurements.

The tire, cellular member, and sensor combination of the present invention 30 thus provides a tire 12 that includes a cellular member 32 with structural features that enable proper mounting, operation, and communication of the sensor 24. With this structure, the sensor opening 36 in the cellular member 32 enables the sensor 24 to be installed and/or removed through the tire cavity 20, regardless of the radial thickness of the cellular member.

The sensor opening 36 enables the cellular member 32 to be formed in a continuous ring structure, as the opening includes a diameter 42 that is less than the width 46 of the cellular member. Such a configuration provides continuity and structural integrity for the cellular member 32, while also enabling secure mounting of the sensor 24 or the sensor container 34 to the innerliner 22. The sensor opening 36 also enables direct communication between the sensor 24 and the tire cavity 22 for accurate pressure and/or temperature measurements.

The present invention also includes a method of forming a tire, cellular member, and sensor combination 30. The method includes steps in accordance with the description that is presented above and shown in FIGS. 2-4.

It is to be understood that the structure of the above-described tire, cellular member, and sensor combination 30 may be altered or rearranged, or components or steps known to those skilled in the art omitted or added, without affecting the overall concept or operation of the invention. For example, as described above, the sensor 24 may be directly affixed or attached to the innerliner 22 by an adhesive, or when the sensor container 34 is employed, the sensor container 34 may be affixed or attached to the innerliner by an adhesive. Such attachment also includes the use of alternative means that may not require an adhesive, such as a rubber patch that may be added between the sensor container 34 and the innerliner 22 that is then vulcanized to provide secure attachment, or application of the sensor container to the innerliner before or during curing of the tire 12 to provide secure attachment.

The invention has been described with reference to a preferred embodiment. Potential modifications and alterations will occur to others upon a reading and understanding of this description. It is to be understood that all such modifications and alterations are included in the scope of the invention as set forth in the appended claims, or the equivalents thereof.

What is claimed is:

1. A tire, cellular member, and sensor combination, the combination comprising:
a tire, the tire including:
a pair of sidewalls;
a circumferential tread, the pair of sidewalls extending to the tread; and
an innerliner;
a cellular member, the cellular member being disposed on the innerliner and being formed with a sensor opening; and
a sensor, the sensor being disposed in the sensor opening and being affixed to the innerliner.

2. The tire, cellular member, and sensor combination of claim 1, wherein the cellular member is formed as a circumferentially-extending ring.

3. The tire, cellular member, and sensor combination of claim 1, wherein the cellular member is formed of open-cell foam.

4. The tire, cellular member, and sensor combination of claim 3, wherein the cellular member is formed of a strip of polyurethane foam.

5. The tire, cellular member, and sensor combination of claim 1, wherein the cellular member is attached to the innerliner with an adhesive.

6. The tire, cellular member, and sensor combination of claim 1, wherein the sensor is directly attached to the innerliner.

7. The tire, cellular member, and sensor combination of claim 1, wherein the sensor is disposed in a sensor container.

8. The tire, cellular member, and sensor combination of claim 7, wherein the sensor container is formed of an elastomer.

9. The tire, cellular member, and sensor combination of claim 7, wherein the sensor container is attached to the innerliner with an adhesive.

10. The tire, cellular member, and sensor combination of claim 1, wherein the sensor opening is formed as a closed-wall geometric shape.

11. The tire, cellular member, and sensor combination of claim 10, wherein the sensor opening is circular.

12. The tire, cellular member, and sensor combination of claim 10, wherein the sensor opening includes a diameter that is smaller than a minimum axial width of the cellular member.

13. The tire, cellular member, and sensor combination of claim 12, wherein the diameter of the sensor opening is near the size of the sensor.

14. The tire, cellular member, and sensor combination of claim 12, wherein the diameter of the sensor opening is larger than the sensor.

15. The tire, cellular member, and sensor combination of claim 12, wherein the sensor diameter of the sensor opening is near the size of the sensor container.

16. The tire, cellular member, and sensor combination of claim 12, wherein the diameter of the sensor opening is larger than a sensor container.

17. The tire, cellular member, and sensor combination of claim 1, wherein the sensor opening extends through an entire radial thickness of the cellular member.

18. The tire, cellular member, and sensor combination of claim 17, wherein the sensor opening extends between a tire cavity and the innerliner.

19. The tire, cellular member, and sensor combination of claim 1, wherein the sensor is a tire pressure monitoring system sensor.
